(19) United States
(12) Patent Application Publication
(10) Pub. No.: US 2014/0177605 A1
(43) Pub. Date: Jun. 26, 2014

(54) METHOD FOR TRANSMISSION SCHEDULING BY GROUPING STATIONS

(71) Applicant: ELECTRONICS AND TELECOMMUNICATIONS RESEARCH INSTITUTE, Daejeon (KR)

(72) Inventors: Hyoung Jin KWON, Cheongju (KR); Min Ho CHEONG, Daejeon (KR); Jae Seung LEE, Daejeon (KR); Sok Kyu LEE, Daejeon (KR)

(73) Assignee: ELECTRONICS AND TELECOMMUNICATIONS RESEARCH INSTITUTE, Daejeon (KR)

(21) Appl. No.: 14/052,526

(22) Filed: Oct. 11, 2013

(30) Foreign Application Priority Data
Oct. 11, 2012 (KR) 10-2012-0112767
Oct. 11, 2013 (KR) 10-2013-0121394

(51) Int. Cl. H04W 72/12

(52) U.S. Cl. CPC H04W 72/1278
USPC 370/336

(57) ABSTRACT

Provided is a transmission scheduling method based on station grouping, including performing physical grouping on stations into sectors based on positions of the stations, performing logical grouping of each physical group into logical groups based on a common characteristic of the stations in each physical group, transmitting, to the stations, access scheduling information used to enable each logical group to access an access point at different time intervals, and controlling a station access based on the access scheduling information.

### TECHNICAL FIELD

The present invention relates to a method of performing station transmission scheduling, and more particularly, to a method of performing station transmission scheduling by grouping stations.

### BACKGROUND ART

In a Wireless Local Area Network (WLAN) environment, a presence of an excessive number of stations (STAs) in the network may bring about the hidden node problem. Here, the hidden node problem may refer to contention occurring among the stations in a single base station, such that, the greater a number of the stations in the base station, the greater a probability of contention increasing.

Reducing the number of the stations accessing an identical channel may mitigate contention. An access point (AP) may group the stations in the network and apply, to each group of the stations, different time intervals at which each group is allowed to access the channel.

### DISCLOSURE OF INVENTION

### Technical Goals

An aspect of the present invention provides a transmission scheduling method based on station grouping that may reduce contention among stations. Time intervals at which the stations are allowed to access a channel may be assigned based on physical grouping and logical grouping performed on the stations.

The physical grouping may refer to grouping the stations based on a physical characteristic of the stations, for example, positions of the stations. The logical grouping may refer to grouping the stations based on a logical characteristic of the stations, for example, traffic transmitted by a station.

The physical grouping and the logical grouping may be simultaneously applied, although an order of the application may be different based on a characteristic of an access point.

The groupings may provide an effective signaling and thus, reduce signaling data in a beacon. Also, the groupings may contribute to reduction of power consumption of a station.

### Technical Solutions

According to an aspect of the present invention, there is provided an operation m method of an access point, including performing physical grouping on stations into sectors based on positions of the stations, performing logical grouping on each physical group into logical groups based on a common characteristic of the stations in each physical group, transmitting, to the stations, access scheduling information used to enable each logical group to access the access point at different time intervals; and controlling a station access based on the access scheduling information.

The access scheduling information may include an association identification (AID) space including information on the physical grouping and information on the logical grouping.

The AID space may include pages divided based on the sectors and groups into which the pages are sub-divided based on a common characteristic of the stations.

The common characteristic of the stations in each physical group may include at least one of a station type, a type of traffic received and transmitted by the stations, and a wakeup cycle of the stations.

The controlling may include controlling the station access using a restricted access window (RAW).

The access scheduling information may be transmitted to each logical group at different time intervals.

According to another aspect of the present invention, there is provided an operation method of an access point including grouping stations based on a common characteristic of the stations, dividing, into segments, each group in which the stations are grouped, transmitting, to the stations, access scheduling information used to enable the stations in sectors corresponding to the segments to access the access point at different time intervals, and controlling a station access based on the access scheduling information.

The access scheduling information may include an omni beacon and a sector beacon. The omni beacon may refer to a beacon for all stations and include at least one of a delivery traffic identification message (DTIM), information on the grouping, and information on the m segments. The sector beacon may refer to a beacon for individual stations in the sectors and include a traffic identification map (TIM).

The access scheduling information may include the omni beacon and the sector beacon. The access scheduling information including the omni beacon and the access scheduling information including the sector beacon may be transmitted to the stations at different time intervals.

The common characteristic of the stations may include at least one of a station type, a type of traffic received and transmitted by the stations, and a wakeup cycle of the stations.

According to still another aspect of the present invention, there is provided an operation method of a station, including receiving access scheduling information from an access point and accessing the access point based on the access scheduling information. The access scheduling information may be used to enable the access point to group stations based on a common characteristic of the stations and divide, into segments, each group into which the stations are grouped, and enable the stations in sectors corresponding to the segments to access the access point at different time intervals.

The receiving may include receiving an omni beacon including a DTIM, based on a DTIM cycle of a segment to which the station belongs and a counter of a time point at which the DTIM is received.

The access scheduling information may include the omni beacon. The accessing may include determining, through the DTIM in the omni beacon, whether there is broadcast data to be received by the station and determining, through a TIM in the omni beacon, whether there is data in a block to which the station belongs.

The access scheduling information may include a sector beacon. The accessing may include determining, through a TIM segment in the sector beacon, whether there is buffered unicast data to be received by the station and receiving, based on a result of the determining, the unicast data through a slot assigned to the station.

The access scheduling information may include the sector beacon. When there is data to be transmitted from the station to an uplink, the accessing may include determining, through the sector beacon, the slot assigned to the station or a group to which the station belongs and transmitting the data through the slot.

### Effects of Invention

An aspect of the present invention provides a transmission scheduling method based on station grouping that may reduce a contention among stations. Time intervals at which the stations are allowed to access a channel may be assigned based on physical grouping and logical grouping performed on the stations.

The physical grouping may refer to grouping the stations based on a physical characteristic of the stations, for example, positions of the stations. The logical grouping may refer to grouping the stations based on a logical characteristic of the stations, for example, traffic transmitted by a station.

The physical grouping and the logical grouping may be simultaneously applied, although an order of the application may be different based on a characteristic of an access point.

The groupings may provide an effective signaling and thus, reduce signaling data in a beacon. Also, the groupings may contribute to reduction of power consumption of a station.

### BRIEF DESCRIPTION OF DRAWINGS

FIG. 1 is a diagram illustrating physical grouping according to an embodiment of the present invention;

FIG. 2 is a diagram illustrating an access interval of stations based on an omni beacon and a sector beacon according to an embodiment of the present invention;

FIG. 3 is a diagram illustrating an association identification (AID) space as a result of logical grouping subsequent to physical grouping according to an embodiment of the present invention;

FIG. 4 is a diagram illustrating an AID space as a result of segmentation subsequent to logical grouping according to an embodiment of the present invention;

FIG. 5 is a diagram illustrating a mapping relationship between an AID space and a traffic identification map (TIM) segment as a result of segmentation subsequent to logical grouping according to an embodiment of the present invention;

FIG. 6 is a diagram illustrating a TIM segment scheduling method used to transmit segments to one sector beacon according to an embodiment of the present invention;

FIG. 7 is a diagram illustrating a TIM segment scheduling method used to transmit one segment to one sector beacon according to an embodiment of the present invention;

FIG. 8 is a flowchart illustrating an operation of an access point in a case of performing logical grouping subsequent to physical grouping according to an embodiment of the present invention;

FIG. 9 is a flowchart illustrating an operation of an access point in a case of performing segmentation subsequent to logical grouping according to an embodiment of the present invention; and

FIG. 10 is a flowchart illustrating an operation of a station in a case of performing segmentation subsequent to logical grouping according to an embodiment of the present invention.

### BEST MODE FOR CARRYING OUT THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures.

In a Wireless Local Area Network (WLAN) environment, an excessive number of stations in the network may cause a hidden node problem and thus, a probability of contention occurring among the stations may increase. Reducing the number of the stations allowed to access an identical channel may mitigate the problem. To this end, an access point may perform grouping on the stations in the network and assign, to each group, different time intervals at which each group is allowed to access the channel.

The access point may allow, using a restricted access window (RAW), certain stations to access the access point at an allocated time interval. The access point may designate a group allowed to access the RAW by associating the RAW with grouping and thus, a station (STA) on may be granted an access only at a time interval allocated to the group to which the station belongs, and access at time intervals allocated to other groups may be limited.

Logical grouping, more particularly, grouping performed based on a service provided by an STA, a characteristic of traffic, or a power reduction cycle, may be performed based on a characteristic of stations. Physical grouping, more particularly, grouping performed based on a directional transmission area of an access point, for example, a sector, may be performed based on sectorization of the access point. Thus, applying both groupings in combination may maximize an effect generated by grouping. There are two methods of applying the physical grouping and the logical grouping.

One method may include performing the physical grouping and then dividing each physical group into logical groups. Based on this method, identical physical groups may belong to one sector and thus, the access point may control the groups at the same time when the access point performs a directional communication by sector.

Another method may include performing the logical grouping and then performing the physical grouping. The method may prioritize the logical grouping based on a fact that the physical grouping may be available when the access point additionally possesses a directional transmission capability. The method may involve hierarchical grouping in which each logical group is subgrouped based on the sector. Based on the method, common information on subgroups may be assigned to a high level logical group and individual information assigned to individual stations in the subgroups may be assigned to a low level sector and thus, signaling and data transmission efficiency may be optimized

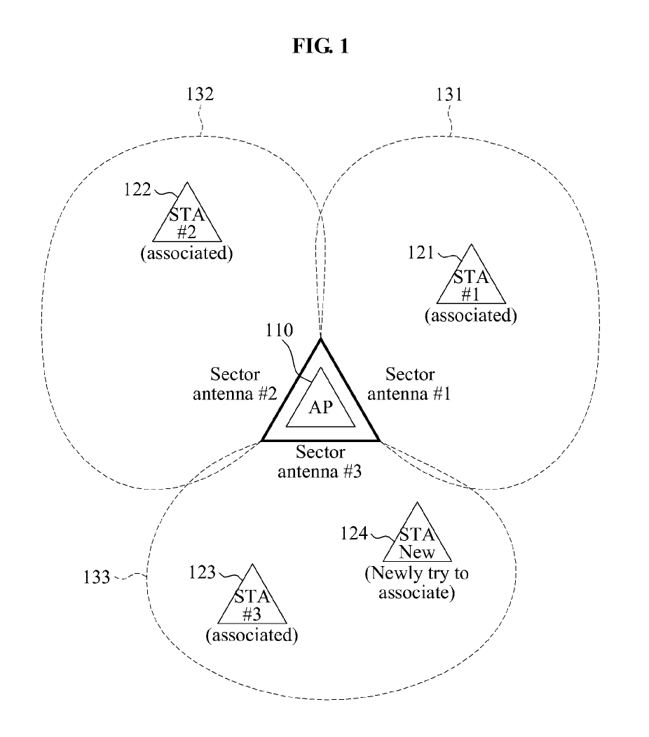

FIG. 1 is a diagram illustrating physical grouping according to an embodiment of the present invention.

FIG. 1 illustrates an access point 110 having a directional function, sectors 131, 132, and 133 which are divided based on positions of STAs 121, 122, 123, and 124, and the stations 121, 122, 123, and 124 in the sectors 131, 132, and 133.

Grouping may include logical grouping and physical grouping. When the access point 110 possesses a directional transmission capability, the physical grouping may include dividing one channel into the sectors 131, 132, and 133 and allowing the stations 121, 122, 123, and 124 to access the channel based on the divided sectors 131, 132, and 133.

FIG. 1 illustrates an example of the physical grouping, and illustrates a spatial configuration of a network when a number of the physically divided sectors is three, for example, sectors 131, 132, and 133. The access point 110 may group the STAs 121, 122, 123, and 124 in areas covered by the sectors 131, 132, and 133 and limit a time interval at which each group may access the channel. The access point 110 may reduce, through sectorization, the number of the STAs 121, 122, 123, and 124 that simultaneously access the channel and thus, mitigate a contention among the stations 121, 122, 123, and 124.

For example, the access point 110 may divide a service time into three time intervals, allow the STA 121 in the sector 131 to access the channel at a first time interval, allow the STA 122 in the sector 132 to access the channel at a second time interval, and allow the STAs 123 and 124 in the sector 133 to access the channel at a third time interval. When a new STA, for example, the STA 124, is detected in a certain sector, for example, the sector 133, the access point 110 may control the STA 124 to access the access point 110 only at a certain time interval allowed for the sector 133.

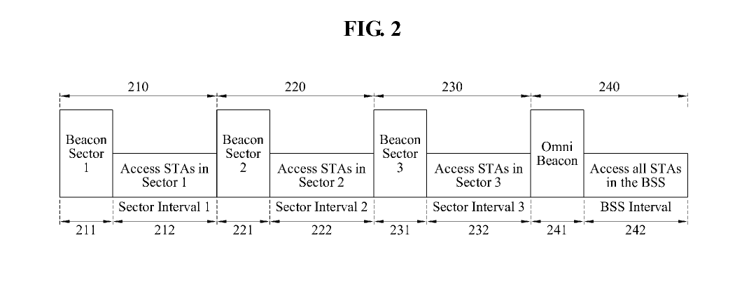

FIG. 2 is a diagram illustrating an access interval of STAs based on an omni beacon and a sector beacon according to an embodiment of the present invention.

FIG. 2 illustrates a interval 210 assigned to a sector 1, a interval 220 assigned to a sector 2, a interval 230 assigned to a sector 3, and a interval 240 assigned to all sectors. The intervals include a beacon interval 211 of the sector 1, an access interval 212 of STAs in the sector 1, a beacon interval 221 of the sector 2, an access interval 222 of STAs in the sector 2, a beacon interval 231 of the sector 3, an access interval 232 of STAs in the sector 3, a beacon interval 240 of the sectors 1 to 3, and an access interval 242 of STAs in the sectors 1 to 3.

To allow only the STAs in each sector to access a channel, an access point may send sector beacons in beacon interval 211, 221, and 231, not an omni beacon. The STAs receiving the sector beacons 211, 221, and 231 may access the channel during assigned sector intervals 212, 222, and 232, respectively, and receive and transmit a packet. The interval 240 assigned to all sectors may perform transmission of a broadcast frame, passive scanning, or association. The interval 240 assigned to all sectors may transmit the omni beacon simultaneously sent to all sectors and allow all STAs to access the channel.

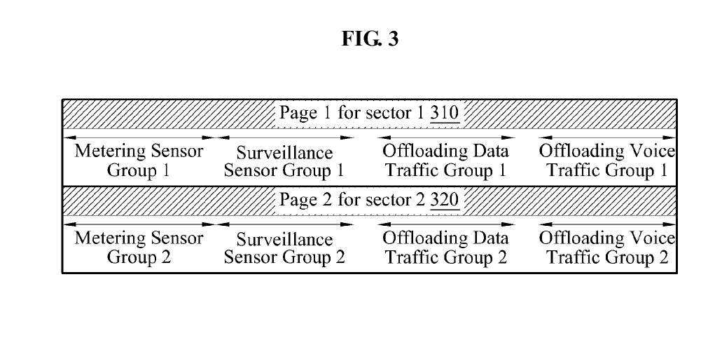

FIG. 3 is a diagram illustrating an association identification (AID) space as a result of logical grouping subsequent to physical grouping according to an embodiment of the present invention.

When an access point performs the physical grouping on STAs into sectors, an STA in a sector may operate as follows. The STA may negotiate a wakeup schedule of the STA with the access point in order to set the wakeup schedule to be one of integer multiples of a sector beacon cycle, to wake up in each wakeup schedule to listen to a beacon, and to verify whether there is buffered data to be received by the STA. Also, when there is data to be sent to the access point, the STA may wake up every wakeup cycle of the STA, access a channel at a sector interval assigned to the sector to which the STA belongs, and transmit the data to the access point.

When an excessive number of the STAs still remain in each sector even after being divided into sectors, re-grouping may be necessary. The access point may determine a standard for the re-grouping based on an STA type, a type of traffic, a wakeup cycle, and the like. Also, the access point may divide an AID space based on a group to manage the STAs in an identical group and assign an AID to each group. The AID may be assigned to each STA subsequent to association.

Using the AID may reduce a size of a traffic identification map (TIM) by including the TIM of STAs having an identical wakeup cycle in a beacon of a corresponding cycle. Also, in a case of STAs having an identical traffic cycle, the TIM may be set to be 1 bit for the STAs simultaneously and thus, a TIM compression effect may be increased.

Referring to FIG. 3, the AID space may be divided into pages 310 and 320 based on the sectors, and the divided pages 310 and 320 may be sub-divided based on a number of logical groups. As shown in FIG. 3, the division may be performed based on whether an STA type is a sensor or an offloading. Also, based on a characteristic of application traffic, the sensor type may be divided into metering and surveillance and the offloading type may be divided into data and voice traffic. The access point may determine a certain AID range based on each physical group and assign the AID to each STA based on the sectors and the STA type/traffic type.

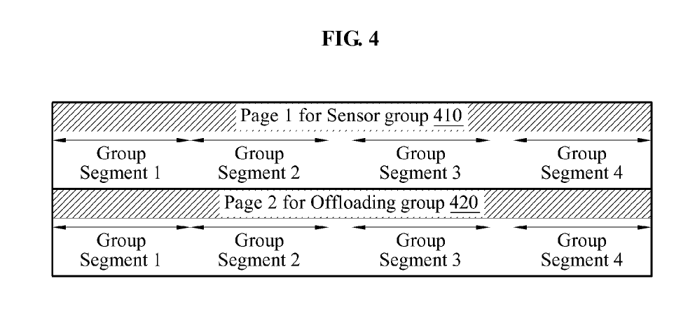

FIG. 4 is a diagram illustrating an AID space as a result of segmentation subsequent to logical grouping according to an embodiment of the present invention.

In hierarchical grouping in which the segmentation is performed subsequent to the logical grouping, an access point may perform the logical grouping first based on an STA type, a traffic type, a wakeup cycle, and the like. Each logical group may be grouped based on sectors to enable an access by a sector. Also, the hierarchical grouping may include dividing STAs based on a type of a sector and an STA, a traffic type, and a wakeup cycle, and accordingly allocating an AID. The difference may be that the access point may manage groups by a unit of a logical group. When the STAs are divided into the sectors within the logical group, a sub-unit called a segment may be used in lieu of a group. Using the segment may reduce overhead required for dividing and managing the groups.

To divide a physical group a concept of the segment may be necessary for an access point not performing sector-based physical grouping. That is, when there are a great number of STAs in one physical group and accordingly, a great number of STAs simultaneously access a channel for receiving downlink data through a TIM after listening to a beacon, the concept of the segment may be applied to reduce the number of the STAs simultaneously accessing a channel by dividing the TIM into segments and including the TIM segments, not an entire TIM, in a beacon.

Referring to FIG. 4, the AID space may be divided into logical groups 410 and 420 by the access point based on the STA type, the traffic type, and the wakeup cycle. Also, the logical groups 410 and 420 may be divided into segments based on a number of sectors. As shown in FIG. 4, the AID space may be divided into the logical groups 410 and 420 based on whether the STAs are of a sensor type or an offloading type, and each of the logical groups 410 and 420 may be divided into the segments based on the sectors. The access point may assign the AID to an STA within an AID range.

In a case of the hierarchical grouping, the access point and an STA may operate as follows.

The access point may manage logical groups. Group information, for example, the number of beacon intervals remaining before the transmission of the TIM to each group, may not be transmitted to a sector beacon, although transmitted through an omni beacon.

When the time for transmitting the TIM to each group approaches, the access point may send a delivery traffic identification message (DTIM) to the omni beacon. The TIM may be segmented and included in the sector beacon corresponding to each segment. In the omni beacon, information on whether buffered data is assigned to each block may be included in a form of a block TIM having a unit of a block, which is a smaller unit than a segment.

An STA may know of a DTIM cycle of a group to which the STA belongs, and listen to the omni beacon including the DTIM information based on information, for example, a counter, which informs the STA of a point in time at which the DTIM in the omni beacon is transmitted.

When there is broadcast data, the STA may receive broadcast data through the DTIM in the omni beacon. Also, when there is data in a block to which the STA belongs, the STA may listen to a sector beacon by which a segment to which the STA belongs is transmitted through the block TIM in the omni beacon.

The STA may verify whether there is buffered unicast data assigned to the STA in the TIM segment in the sector beacon and, when the STA verifies that there is buffered unicast data, the STA may send (NDP) PS-POLL in a slot assigned to the STA and received the data in a slot subsequently assigned to the STA.

When there is data to be sent to an uplink, although there is no buffered data assigned to the STA, the STA may listen to the sector beacon and transmit the data in the slot/RAW assigned to the STA or the group to which the STA belongs, through a channel access based on Carrier Sense Multiple Access (CSMA)/Collision Avoidance (CA)

Table 1 outlines differences between the two grouping methods illustrated in FIG. 3 and FIG. 4.

| | Method | Method |
|---|---|---|
| | illustrated in FIG. 3 | illustrated in FIG. 4 |
| Group information | per sector | per omni |
| Broadcast frequency | # of sector | 1 |
| Beacon listen frequency | 1 (sector only) | 2 (omni + sector) |
| TIM IE (omni) | N/A | per group (usually page) |
| TIM IE (sector) | per page | per segment |
| RAW group for all STAs | per page | per segment |
| of one sector | | |

FIG. 3 illustrates an example in which the number of groups is a result of multiplying the number of logical groups by the number of sectors. FIG. 4 illustrates an example in which the number of the logical groups is the number of all groups. Thus, the group information used to inform each group in a beacon of necessary information may need to match the number of groups. In a case of a broadcast or a frame identically sent to the logical groups, the method illustrated in FIG. 3 may send the frame to each sector and conversely, the method illustrated in FIG. 4 may send the frame only to an omni beacon. A beacon listen frequency may be higher in the method illustrated in FIG. 4, in which an STA also listens to the omni beacon, than in the method illustrated in FIG. 3, in which the STA listens to only the sector beacon. Also, when compared to the method illustrated in FIG. 3, the method illustrated in FIG. 4 may add TIM segment information not only to the sector beacon but also to the omni beacon. In a case of a TIM, the method illustrated in FIG. 3 may gather, in one page, STAs of one sector and thus, not send the TIM of the groups in the one sector to each group. However, an AID range covering the page may be designated in one TIM to gather all TIMs of different groups, and send one TIM IE.

Based on the method illustrated in FIG. 3, when there are several groups capable of accessing one RAW from one sector, an AID space is connected and thus, the access point may record, in the AID space, the groups capable of accessing the RAW from the sector all at once. Based on the method illustrated in FIG. 4, when there are several groups capable of accessing the RAW from the sector, an AID of a different logical group is assigned to a different page and thus, a number of RAW PS IEs corresponding to a number of the logical groups may be added by the access point to a beacon.

The two grouping methods may be modified based on a Basic Service Set (BBS) environment. For example, as shown in FIG. 2, the access point may transmit an omni beacon and sector beacons. Here, the omni beacon may be transmitted in a form of an existing full beacon, and the sector beacons may be transmitted in a form of being optimized m in the full beacon and mapped to a short beacon excluding several pieces of information. In this case, the method illustrated in FIG. 4 may be more effective because common information may be sent to the omni beacon to reduce an amount of information inserted in the short beacon. In a case of assigning a high priority to an STA power saving effect, the method illustrated in FIG. 3 may be more effective because the STA may listen to only the sector beacon and access a channel. Thus, the access point may select a method optimal for a communication environment between the two methods.

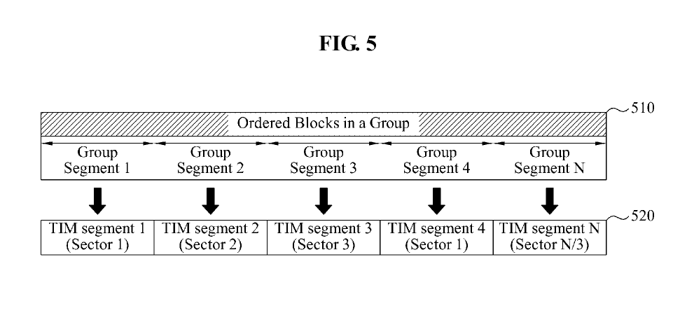

FIG. 5 is a diagram illustrating a mapping relation between an AID space and a TIM segment as a result of segmentation subsequent to logical grouping according to an embodiment of the present invention.

FIG. 5 illustrates an example of a sector based AID assignment of a method illustrated in FIG. 4. For the AID assignment, it is presumed that (1) an access point possesses an AID space corresponding to a logical group, and the AID space is divided into segments based on the number of sectors, (2) the number of STAs in one sector may not be known in advance and association of the STAs is performed randomly, not at once, and (3) due to TIM segments being divided in a fixed size, a size of a segment is not changed by the number of the STAs in the sector. In view of the preceding presumptions, FIG. 5 illustrates an example of mapping the AID space and a TIM segment in a group.

The access point may divide the AID space assigned to a logical group into segments, in a fixed size, in proportion to a number of sectors, and incrementally assign the STAs associated with each segment to a corresponding segment. The access point may not know of an exact number of the STAs and allow an entire AID space for the STAs in other logical groups. Thus, the segments may not be additionally assigned to the STAs exceeding the size of the segments initially assigned. In this case, to prevent reassignment of the AID previously assigned to the STAs, segments 4, 5, and 6 having an identical size as existing segments may be additionally assigned in the AID space. Here, a value obtained through a modular calculation on each segment ID value as the number of the sectors may indicate a sector assigned to an STA in a segment. Subsequent to the assignment of the sectors based on the segments, the STA may determine, through a beacon, when a TIM segment to which the STA belongs is to be delivered and access a channel through a determined sector beacon.

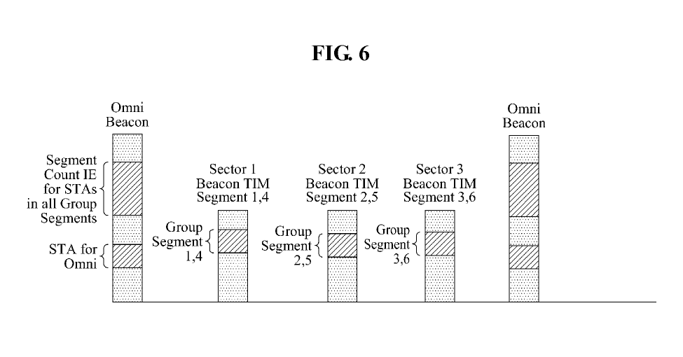

FIG. 6 is a diagram illustrating a TIM segment scheduling method used to transmit segments to a sector beacon according to an embodiment of the present invention.

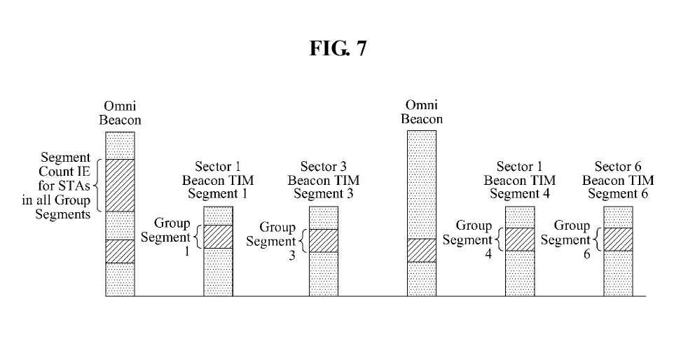

There are two TIM segment scheduling methods. One is illustrated in FIG. 6 in which the segments are transmitted to one sector beacon and the other is illustrated in FIG. 7 in which one segment is transmitted to one sector beacon.

Based on the method of transmitting the segments to one sector beacon, STAs in the segments may simultaneously access the sector beacon to which the STAs belong. When an access point records the number of segments, in a segment count IE in a DTIM beacon, the STAs may calculate a size of one segment by dividing the number of blocks in an AID space of which the STAs already known by the number of the segments. A unit of the size is indicated as a block. A first segment among the TIM segments may be included in the DTIM beacon, and segments from a second one onwards may be included one by one in beacons after the DTIM beacon.

Two fields indicating that the segments are assigned to one sector beacon may be included in the segment count IE. One field may indicate whether the sector is grouped, and the other field may indicate an existence of a cycle. When the sector grouping field is determined, it may indicate that grouping based on sectors is applied. In this case, the TIM segments may not be included in the omni beacon. Thus, a first TIM segment may not be included in the omni beacon and start from a sector beacon subsequent to the omni beacon. Also, when the cycle field is determined, it may indicate that an order of the sector beacon corresponding to the segment to which the STA belongs is calculated using a modular calculation.

FIG. 6 illustrates an example in which the number of segments is six and the number of sectors is three. A value obtained using the modular calculation on segment IDs and the number of the sectors may be the number of sector beacons. A first segment and fourth segment may be assigned to sector beacon 1, and a second segment and a fifth segment may be assigned to sector beacon 2.

FIG. 7 is a diagram illustrating a TIM segment scheduling method used to transmit one segment to one sector beacon according to an embodiment of the present invention.

The method may be an example in which a cycle field illustrated in FIG. 6 is determined to be “0.” Referring to FIG. 7, when the number of sectors is three, segments 4, 5, and 6 which have a greater value than the number of the sectors may be included in a fourth, a fifth, and a sixth sector beacons, respectively, subsequent to an omni beacon. An STA may know of, in advance, an omni beacon cycle and the number of the sectors and thus, may easily calculate when a sector beacon including a TIM segment to which the STA belongs is transmitted.

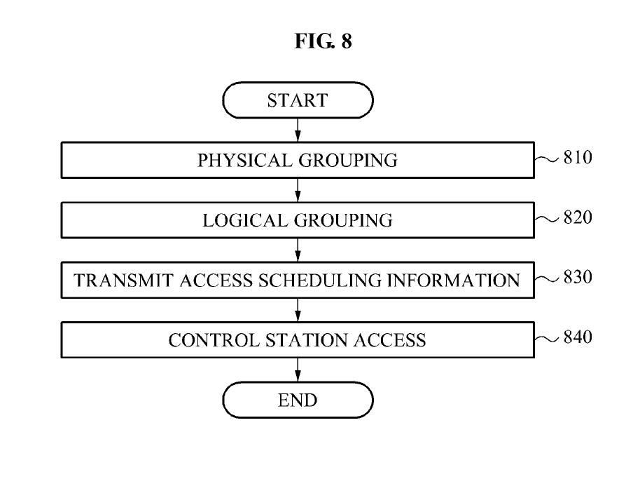

FIG. 8 is a flowchart illustrating an operation of an access point in a case of performing logical grouping subsequent to physical grouping according to an embodiment of the present invention.

Referring to FIG. 8, in operation 810, the access point may perform physical grouping.

The physical grouping may refer to sectorization of STAs based on a position of each STA. For example, the access point may classify, as a sector, each of three areas divided based on a radius of the access point.

In operation 820, the access point may perform logical grouping.

The logical grouping may be performed based on a common characteristic of the STAs.

The common characteristic of the STAs may include at least one of an STA type, a type of traffic received and transmitted by the STAs, and a wakeup cycle of the STAs. The logical grouping may be performed on each physical group after the physical grouping. After operation 820 is completed, the STAs are divided by the number of physical groups and logical groups.

In operation 830, the access point may transmit access scheduling information to the STAs.

The access scheduling information may be used to control an access of the logical groups to the access point. Also, the access scheduling information may be used to schedule the STAs in different logical groups to access the access point at different time intervals. The access point may generate the access scheduling information through a RAW.

The access scheduling information may be transmitted to the STAs through a beacon signal. The beacon signal may include an omni beacon transmitted to all the STAs and a sector beacon transmitted to certain STAs in a certain sector. The access scheduling information may include an AID space. The AID space may include information on the physical grouping and information on the logical grouping. Also, the AID space may include a number of page divisions corresponding to the number of the sectors and groups into which the pages are divided based on a common characteristic of the STAs.

The access scheduling information may be transmitted to each sector at different time intervals or transmitted to each logical group at different time intervals. Here, the access scheduling information to be transmitted may include the omni beacon and the sector beacon. The access scheduling information to be transmitted to a certain sector may include the sector beacon to be transmitted to the certain sector.

In operation 840, the access point may control an STA access. The access point may control the STA access based on the access scheduling information. The access point may control, using the RAW, the STA access.

An STA may determine a wakeup schedule of the STA to be one of integer multiples of a sector beacon cycle by negotiating with the access point, wake up every wakeup schedule to listen to a beacon, and verify whether there is buffered data to be received by the STA. Also, when there is data to be sent to the access point, the STA may wake up in the wakeup cycle, access a channel at a sector interval assigned to the STA, and transmit the data to the access point.

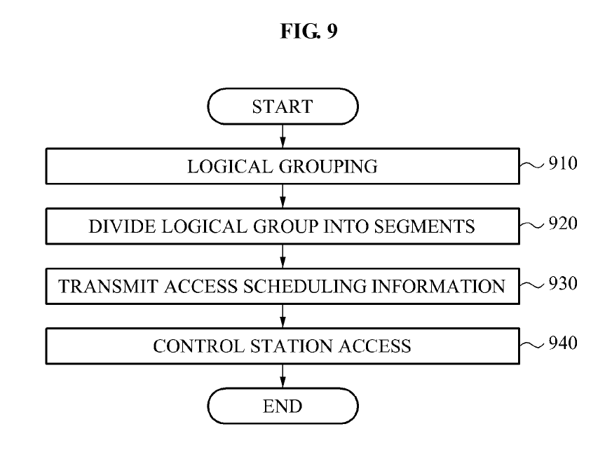

FIG. 9 is a flowchart illustrating an operation of an access point in a case of performing segmentation subsequent to logical grouping according to an embodiment of the present invention.

Referring to FIG. 9, in operation 910, the access point may perform logical grouping.

The access point may perform the logical grouping on all STAs before physical grouping. The logical grouping may be performed based on a common characteristic of the STAs.

In operation 920, the access point may divide each logical group into segments.

Only the logical grouping may be applied to the STAs and thus, the number of groups after grouping may be equal to the number of logical groups. Thus, the access point may manage the groups only by a unit of a logical group. However, each logical group may be divided into segments and the access point may control the STAs by a unit of a segment. Using the segment unit may reduce overhead required to divide and manage the groups.

The segmentation in operations 910 and 920 may be also applied to the access point having no directional capability.

In operation 930, the access point may transmit access scheduling information to the STAs.

The access scheduling information may be used to control an access, to the access point, of an STA in each segment. Also, the access scheduling information may be used to enable the STAs in each different segment to access the access point at different time intervals. The access point may generate the access scheduling information through a RAW.

The access scheduling information may be transmitted to the STAs through a beacon signal. The beacon signal may include an omni beacon to be transmitted to all the STAs and a sector beacon to be transmitted to an STA in a certain sector. The sector beacon may include a beacon to be transmitted to an STA in a certain segment.

The omni beacon may include at least one of a DTIM, information on logical grouping, and information on the segments. When a time to transmit a TIM for each group approaches, the access point may send the DTIM to the omni beacon. Although group information is transmitted through the omni beacon, group information may not be transmitted to the sector beacon. The omni beacon may include, in a form of a block TIM, information on whether there is buffered data assigned to each block.

The sector beacon may include the TIM. The TIM may be segmented and included in the sector beacon corresponding to each segment.

The omni beacon and the sector beacon may be transmitted at different time intervals. Also, the sector beacon corresponding to different segments may be transmitted at different time intervals.

In operation 940, the access point may control an STA access to the access point.

The access point may control the STA access based on the access scheduling information. The access point may control, using the RAW, the STA access.

After the omni beacon is transmitted, the access point may receive a replay to the omni beacon from all the STAs during a certain time interval. After the sector beacon is transmitted, the access point may receive a replay to the sector beacon from an STA in a corresponding sector during a certain time interval.

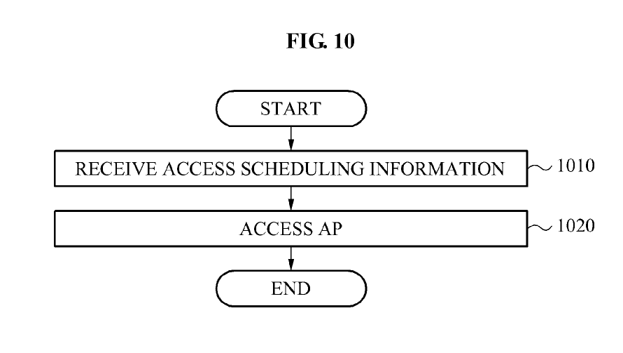

FIG. 10 is a flowchart illustrating an operation of an STA in a case of performing segmentation subsequent to logical grouping according to an embodiment of the present invention.

Referring to FIG. 10, in operation 1010, the STA may receive access scheduling information from an access point.

The access scheduling information may be used to enable the access point to perform grouping on STAs based on a common characteristic of the STAs and divide each group obtained through the grouping into segments, and to schedule the STAs in sectors corresponding to the segments to access the access point at different time intervals. The access scheduling information may be information in which an STA access is scheduled based on methods illustrated in FIGS. 4 and 9.

The access scheduling information may include an omni beacon and a sector beacon. The omni beacon may include at least one of a DTIM, information on logical grouping, and information on the segments. Although group information is transmitted through the omni beacon, group information may not be transmitted to the sector beacon. The omni beacon may include, in a form of a TIM, information on whether there is buffered data assigned to each block.

The sector beacon may include the TIM. The TIM may be segmented and included in the sector beacon corresponding to each segment.

The STA may know of a DTIM cycle of a group to which the STA belongs and listen to the omni beacon including DTIM information, based on information on a time point at which the DTIM in the omni beacon is transmitted. When there is broadcast data, the STA may receive the data through the DTIM in the omni beacon. Also, when there is data assigned to a block to which the STA belongs, the STA may listen to, through a block TIM in the omni beacon, the sector beacon in which a segment to which the STA belongs is transmitted.

In operation 1020, the STA may access the access point based on the access scheduling information.

The STA may verify whether there is buffered unicast data assigned to the STA in a TIM segment in the sector beacon. When there is the buffered unicast data assigned to the STA, the STA may send (NDP) PS-POLL in a slot assigned to the STA and receive the data in a slot subsequently assigned to the STA. When there is data to be sent to an uplink, although the buffered data is absent, the STA may listen to the sector beacon of the STA and access a channel in the slot/RAW assigned to the STA based on CSMA/CA.

The above-described exemplary embodiments of the present invention may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

1. An operation method of an access point, the method comprising:
performing physical grouping on stations into sectors based on positions of the stations;
performing logical grouping on each physical group into logical groups, based on a common characteristic of the stations in each physical group;
transmitting, to the stations, access scheduling information used to enable each logical group to access the access point at different time intervals; and
controlling a station access based on the access scheduling information.

2. The method of claim 1, wherein the access scheduling information comprises an association identification (AID) space comprising information on the physical grouping and information on the logical grouping.

3. The method of claim 2, wherein the AID space comprises pages divided based on the sectors and groups into which the pages is sub-divided based on a common characteristic of the stations.

4. The method of claim 1, wherein the common characteristic of the stations in each physical group comprises at least one of a station type, a type of traffic received and transmitted by the stations, and a wakeup cycle of the stations.

5. The method of claim 1, wherein the controlling comprises controlling the station access using a restricted access window (RAW).

6. The method of claim 1, wherein the access scheduling information is transmitted to each logical group at different time intervals.

7. An operation method of an access point, the method comprising:
grouping stations based on a common characteristic of the stations;
dividing, into segments, each group in which the stations are grouped;
transmitting, to the stations, access scheduling information used to enable the stations in sectors corresponding to the segments to access the access point at different time intervals; and
controlling a station access based on the access scheduling information.

8. The method of claim 7, wherein the access scheduling information comprises an omni beacon and a sector beacon,
wherein the omni beacon refers to a beacon for all stations and comprises at least one of a delivery traffic identification message (DTIM), information on the grouping, and information on the segments, and
wherein the sector beacon refers to a beacon for individual stations in the sectors and comprises a traffic identification map (TIM).

9. The method of claim 7, wherein the access scheduling information comprises an omni beacon and a sector beacon, and
wherein the access scheduling information comprising the omni beacon and the access scheduling information comprising the sector beacon are transmitted to the stations at different time intervals.

10. The method of claim 7, wherein the common characteristic of the stations comprises at least one of a station type, a type of traffic received and transmitted by the stations, and a wakeup cycle of the stations.

11. An operation method of a station, the method comprising:
receiving access scheduling information from an access point; and
accessing the access point based on the access scheduling information, and
wherein the access scheduling information is used to enable the access point to group stations based on a common characteristic of the stations and divide, into segments, each group in which the stations are grouped, and enable the stations in sectors corresponding to the segments to access the access point at different time intervals.

12. The method of claim 11, wherein the receiving comprises receiving an omni beacon comprising a delivery traffic identification message (DTIM), based on a DTIM cycle of a segment to which the station belongs and a counter of a time point at which the DTIM is received.

13. The method of claim 11, wherein the access scheduling information comprises an omni beacon, and the accessing comprises:
determining, through a DTIM in the omni beacon, whether there is broadcast data to be received by the station and determining, through a block traffic identification map (TIM) in the omni beacon, whether there is data in a block to which the station belongs.

14. The method of claim 11, wherein the access scheduling information comprises a sector beacon, and the accessing comprises:
determining, through a TIM segment in the sector beacon, whether there is buffered unicast data to be received by the station; and
receiving, based on a result of the determining, the unicast data through a slot assigned to the station.

15. The method of claim 11, wherein the access scheduling information comprises a sector beacon and, when there is data to be transmitted from the station to an uplink, the accessing comprises:
determining, through the sector beacon, a slot assigned to the station or a group to which the station belongs; and
transmitting the data through the slot.
